(19) United States
(12) Patent Application Publication
(10) Pub. No.: US 2026/0208959 A1
(43) Pub. Date: Jul. 23, 2026

(54) SELF-RETRACTING PALLET RETENTION DEVICE

(71) Applicant: National Presort, LLC, Fort Worth, TX (US)

(72) Inventors: Brent Daboub, Fort Worth, TX (US); Fred Ayala, Fort Worth, TX (US)

(21) Appl. No.: 19/140,887

(22) PCT Filed: Dec. 12, 2023
(86) PCT No.: PCT/US2023/083516

§ 371 Date: Jun. 18, 2025

Related U.S. Application Data
(60) Provisional application No. 63/434,166, filed on Dec. 21, 2022.

(51) Int. Cl. B65G 7/08

(52) U.S. Cl. CPC B65G 7/08

(57) ABSTRACT

A product unloader for product sortation systems includes a self-retracting pallet retention device for capturing and retaining upended pallets. The product unloader has at least one self-retracting pallet catch. The pallet catch includes a connector for maintaining the catch in an operative position, a guide configured for directing movement of the connector between raised and lowered positions, and a limiter defining the guide positions. The connector, guide, and limiter combine to allow the catch to move by force of gravity about an axis of rotation of the connector. The catch further includes a catch edge that is in contact with the pallet.

### TECHNICAL FIELD

The present application relates to unloader (otherwise called tipper or dumper) systems. In particular, the present application relates to an unloader system designed to remove product from a container.

### DESCRIPTION OF PRIOR ART

Generally, unloaders for sortation equipment facilitate the removal of product from containers. Unloaders are often used to dump containers such as gaylords, carts, or similar containers by rotating them about an axis until the product falls out of said container. Unloaders typically have container stops to capture such containers to prevent them from falling onto or in the area where the product is being dumped in.

Some products are placed on top of a pallet and not inside a container. Pallets are not tall enough for the container stops to capture them. When an unloader is used to unload a pallet with product, it is common for the pallet to fall onto or in the area where product is being dumped, thus requiring the operator or another worker to take another action and disrupt their workflow.

Although the aforementioned systems for removing products from a container represent great strides in the field of unloading systems, many shortcomings remain.

### BRIEF DESCRIPTION OF THE DRAWINGS

The novel features believed characteristic of the present application are set forth in the appended claims. However, the present application itself, as well as a preferred mode of use, and further objectives and advantages thereof, will best be understood by reference to the following detailed description when read in conjunction with the accompanying drawings, wherein;

FIG. 1 is an isometric view of an unloader system according to a preferred embodiment of the present application;

FIG. 2 is a rear perspective view of the unloader system of FIG. 1;

FIG. 3 is an isometric view of the unloader system of FIG. 1 in an actuated position;

FIG. 4A is front view of the unloader system of FIG. 1 with an additional pallet;

FIG. 4B is a cross-sectional view of the unloader system, taken at 4B-4B of FIG. 4A;

FIG. 5A is a perspective view of a front pallet catch according to a preferred embodiment of the present application;

FIG. 5B is a side view of a retracting pallet catch according to a preferred embodiment of the present application;

FIG. 6 is a front view of the unloader system of FIG. 1;

FIG. 7A is perspective view of a static front pallet catch for an unloader system according to an alternative embodiment of the present application;

FIG. 7B is a side view of the static front pallet catch of FIG. 7A;

FIG. 8A is perspective view of a self-retracting pallet catch for the unloader system of FIG. 1;

FIG. 8B is a side view of the self-retracting pallet catch of FIG. 8A;

FIG. 9A is an isometric view of the unloader system of FIG. 1;

FIG. 9B is a front view of the unloader system of FIG. 9A;

FIG. 10 is an isometric view of an unloader system in an actuated position according to a alternative embodiment of the present application;

FIG. 11 is a back view of the unloader system of FIG. 10; and

FIG. 12 is a side view of the unloader system of FIG. 10.

While the assembly of the present application is susceptible to various modifications and alternative forms, specific embodiments thereof have been shown by way of example in the drawings and are herein described in detail. It should be understood, however, that the description herein of specific embodiments is not intended to limit the present application to the particular embodiment disclosed, but on the contrary, the intention is to cover all modifications, equivalents, and alternatives falling within the spirit and scope of the present application as defined by the appended claims.

### DESCRIPTION OF THE PREFERRED EMBODIMENT

Illustrative embodiments of the system of the self-retracting pallet holder of the present application are described below. In the interest of clarity, not all features of an actual implementation are described in this specification. It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower”, or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The present application is particularly unique at least in that it allows both pallets and containers of product to have unrestricted movement into or out of the product receptacle. While the product receptacle is being inverted, the self-retracting pallet holder restricts the movement of the pallet so the pallet will remain in the product receptacle. Once the risk of pallet movement is reduced, the retention device moves out of the way so unrestricted access to the pallets and containers of product is provided.

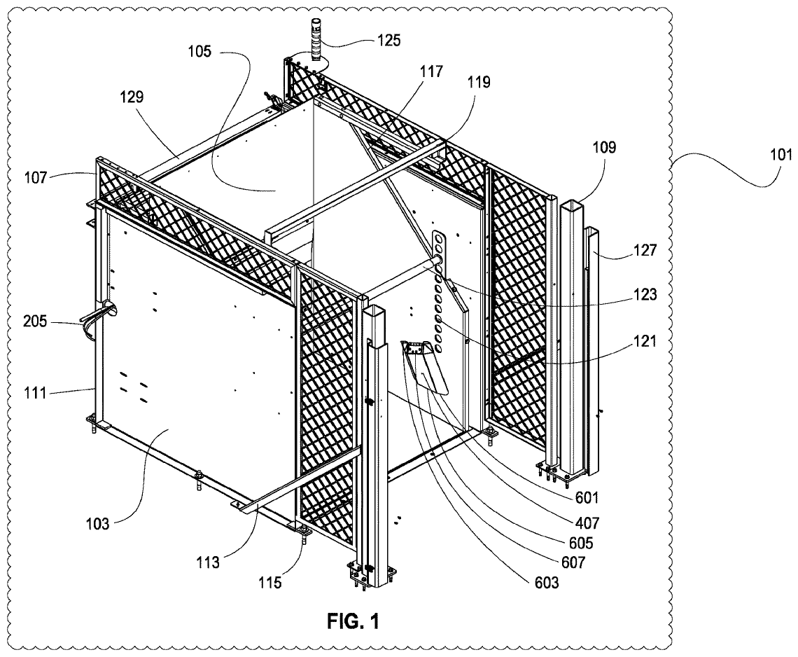

Referring now to FIG. 1 in the drawings, a front perspective view of an unloader system 101 is depicted according to a preferred embodiment of the present application. As shown in FIG. 1, unloader system 101 is generally comprised of a pair of unloader frame side walls 103, product receptacle 105, a pair of wire fence walls 107, forward support bar 109, back support bar 111, diagonal support bar 113, fasteners 115, slanted slope of receptacle 117, upper container stop 119, fastening holes 121, adjustable container stop 123, lamp stack 125, safety curtain support bar 127, back limit bar 129, connecting wire 205, and self-retracting pallet catch 407. Unloader frame side walls 103 are statically mounted to the ground creating a main loader area where receptacle 105 is located.

Wire fence walls 107 have a lattice pattern and are attached to frame side walls 103 providing an extended cover preventing items from falling out of receptacle 105 when receptacle 105 is lifted. Attached to the front of fence walls 107 are forward support bars 109 and safety curtain support bars 127. Forward support bar 109 is secured to the ground using fasteners 115 which increase the stability of unloader 101 at the front of the system. Fastened to the side of support bar 109 is diagonal support 113 which extends down at an angle to connect to the ground. Diagonal support 113 may be connected to support bar 109 through welding or other fasteners and is secured to the ground using fasteners 115. Diagonal support 113 distributes the weight placed upon support bar 109 to better secure and stabilize unloader 101 while in use. At the back end of unloader 101 there is back support bar 111 which provides another location where fasteners 115 are used to secure unloader 101 to the ground to improve the stability of the system. It is appreciated that these are not the only locations where fasteners 115 are used to secure unloader 101 to the ground and that fasteners 115 or any other means of fastening can be used elsewhere to secure unloader 101 to the ground and improve the stability of unloader 101.

Other features included on support frame side walls 103 are lamp stack 125, safety curtain support bar 127, and back limit bar 129. Lamp stack 125 is a cylindrical support attached at the top of one of the back ends of fence walls 107. Stack 125 provides a location where a signaling light can be attached which will activate when unloader 101 is in use. Having a signaling light active provides a way for operators to know when unloader 101 is and is not in use. Another safety feature of unloader 101 is safety curtain support bar 127 attached to forward support bar 109. Safety curtain support bar 127 provides a location where operators can hang a safety curtain to block the entrance to unloader 101 while receptacle 105 is in use. The safety curtain would catch any products which may fall forward out of receptacle 105 when being raised to the active position. Connecting the backs of support frame side walls 103 is back limit bar 129 which extends between the top of support frame side walls 103 while limiting how far back receptacle 105 can pivot when tilted. Limit bar 129 is positioned so that receptacle 105 will stop at an ideal angle such that the contents will fall out of receptacle 105 at a steady pace. The angle that limit bar 129 stops receptacle 105 will also prevent the contents from falling at a speed where the contents will be damaged on impact in the sorting area after leaving receptacle 105. If receptacle 105 did not tilt back far enough, receptacle's 105 contents would not fall at a steady place, but if receptacle 105 titled back beyond what limit bar 129 would allow the contents of receptacle 105 would have an increased chance of being damaged after leaving receptacle 105.

Secured within the confines of support frame side walls 103 is receptacle 105 which holds the products that will later be emptied for sorting. Receptacle 105 is structured as a square box that is open at the top and front with a slanted edge 117 starting on the top of the side walls of receptacle 105 and running to the front of receptacle 105 to create a cut out portion of receptacle 105. Receptacle 105 is further comprised of upper container stop 119, fastening holes 121, and adjustable container stop 123. Upper container stop 119 is formed from a pair of bars that extend from the top of the side walls of receptacle 105 out over the space cut out by slanted edge 117 which then extends out over the empty space in receptacle 105 to connect. Upper container stop 119 prevents taller containers from falling out of receptacle 105 when unloader 101 is tilted back. When receptacle 105 is moved into the active position, container stop 119 will hold the larger containers in place within receptacle 105 to prevent the containers from also falling out. Receptacle 105 also has adjustable container stop 123 secured within fastening holes 121. Fastening holes 121 are located towards the bottom end of slanted edge 117 and extend down until reaching the location where self-retracting pallet catch 407 is located. Fastening holes 121 also extend above slanted edge 117 using a sheet of material to expand where adjustable stop 123 can be inserted. Adjustable stop 123 is spring loaded and when pressure is applied on both sides, the spring inside is condensed and decreases how far across stop 123 can stretch allowing an operator to place stop 123 within fastening holes 121. This allows an operator to set the desired height for where to place adjustable stop 123 depending on the type of containers the operator is sorting. Like upper container stop 119, adjustable stop 123 secures boxes or other containers in place within receptacle 105 so that boxes or containers will not fall out when unloader 101 is operational.

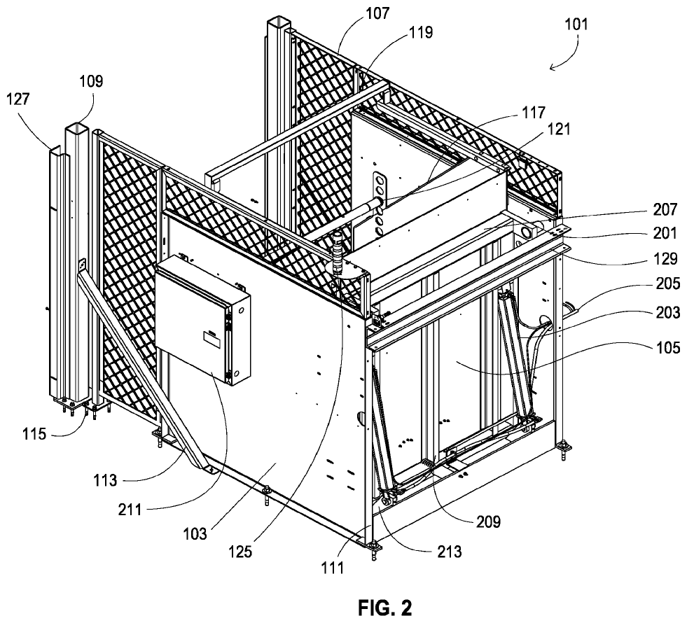

Referring now also to FIG. 2 in the drawings, a perspective view of the back of unloader system 101 is depicted according to the preferred embodiment of the present application. FIG. 2 provides another view of the structure of unloader system 101 outlined in the discussion on FIG. 1 while also providing a view of other features of unloader 101. As shown in FIG. 2, unloader system 101 further comprises a rotational joint 201, linear actuators 203, connecting wires 205, receptacle attachment bar 207, back support bars 209, control panel 211, and support frame back base 213. Rotational joint 201 is located on the inner side of unloader frame side walls 103 at the top back edge of frame side walls 103 and, along with actuators 203, is used to rotate receptacle 105 for unloading. Rotational joint 201 is connected to receptacle 105 by attachment bar 207 which spans the length between the two rotational joints 201 connected on each frame side wall 103.

Attached at the back of receptacle 105, there are two linear actuators 203 which are connected to back support bars 209 to lift receptacle 105. Wires 205 connect linear actuators 203 to a hydraulic pump which is not currently shown in these drawings. Once activated, the hydraulic pump will raise linear actuators 203 which will lift receptacle 105 up from the rest position. This motion will continue until either the individual stops the hydraulic pump or until receptacle 105 reaches limit bar 129 which will prevent receptacle 105 from pivoting further. Back support bars 209 run the vertical length of receptacle 105 until reaching base 213 which provides extra support and stability in maintaining the structure of receptacle 105. Back support bars 209 are connected to linear actuators 203 and are the point where receptacle 105 will be raised.

The movement of actuators 203 to lift and lower receptacle 105 from the lowered position to the raised position is controlled by an operator using control panel 211. Control panel 211 is located on the outer side of either support frame side wall 103. Control panel 211 is further contained within a secure box which may be closed and locked when not in use. It is appreciated that control panel 211 may be operated directly at unloader 101 itself or control panel 211 may be operated remotely using a controller or an application to manage the system remotely.

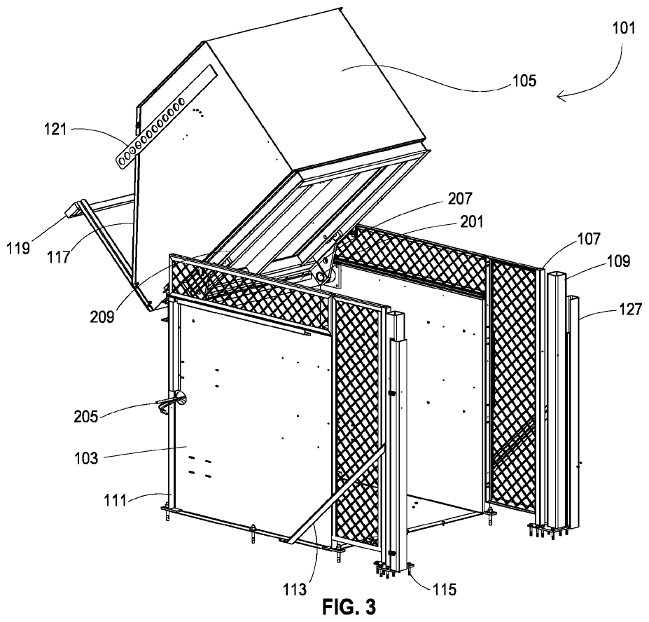

Referring now also to FIG. 3 in the drawings, receptacle 105 is shown in the raised position. FIG. 3 depicts unloader 101 when in operation and when linear actuators 203 have fully lifted receptacle 105 into the raised position. When lifted into this position, the top opening of receptacle 105 is at a desired angle such that the objects falling out do not fall at a great enough speed to cause substantial damage to the objects when landing in the sorting area. The containers which were holding these items are also secured using upper container stop 119 and/or adjustable container stop 123 to prevent the containers from falling into the sorting area.

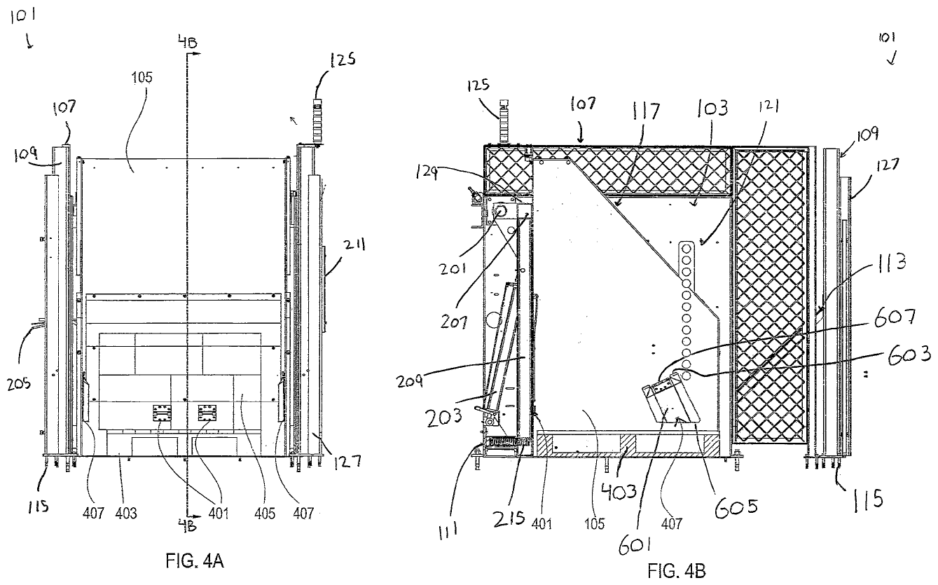

Referring now also to FIGS. 4A and 4B in the drawings, a front and cross-sectional view of unloader 101 is depicted when in use. Along with what was described above, FIGS. 4A and 4B depicted unloader 101 further comprising a support spring 215, a front pallet catch 401, a pallet 403, product 405 (made transparent for clarity of viewing), and self-retracting pallet catch 407. Support spring 215 is shown in the cross-sectional view of FIG. 4B located within base 213. Spring 215 is utilized to catch receptacle 105 when actuators 203 lower receptacle 105 into the rest position. When actuators 203 are lowering receptacle 105, receptacle 105 will press against spring 215 which will provide a counter spring force against receptacle 105 slowing the descent into the rest position. It is preferred that receptacle 105 have a slower descent so that receptacle 105 does not collide with unloader 101 damaging any equipment. FIGS. 4A and 4B further show how unloader holds onto pallets and products by depicting at least one front pallet catch 401 and two self-retracting pallet catches 407 oriented on opposite walls from each other. However, it is appreciated that an alternative embodiment may exist where a receptacle 105 will have more than one front pallet catch 401 or may have less than two or more than two self-retracting pallet catches 407. These devices are shown and further described below.

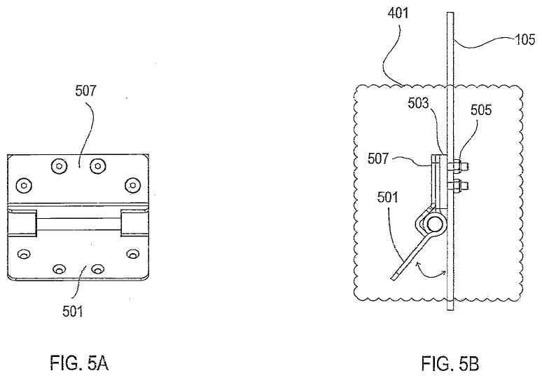

Referring now also to FIGS. 5A and 5B in the drawings, a front pallet catch 401 is depicted as comprising a spring hinge 501, which is tensioned to actuate hinge 501 until hitting hinge stop 507; and a spacer plate 503 is used along with mounting hardware 505 to mount spring hinge 501 to the sidewall of product receptacle 105. Hinge 501 can be rotated inward towards the wall of product receptacle 105 if sufficient pressure is applied, such as when a tall container is pressed against spring hinge 501. This allows the edge surface of spring hinge 501 to be moved out of the way for non-pallet type of containers. If pressure is applied in the opposite direction, such as when a pallet is laying on the edge of the spring hinge 501 when receptacle 105 is raised in the active position, spring hinge 501 cannot move because of hinge stop 507 retaining the pallet in the product receptacle 105.

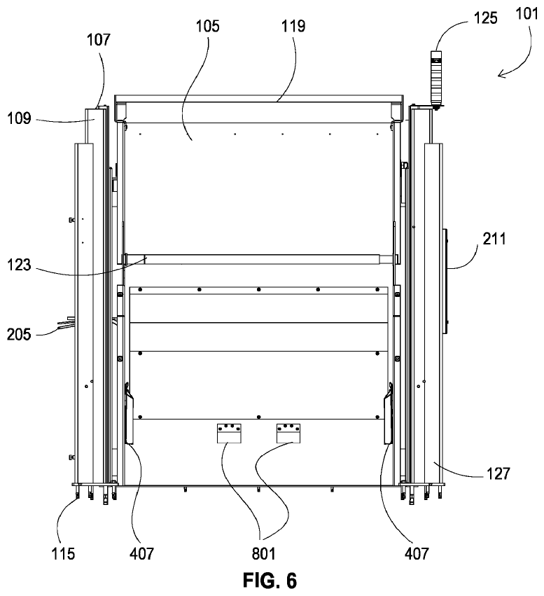

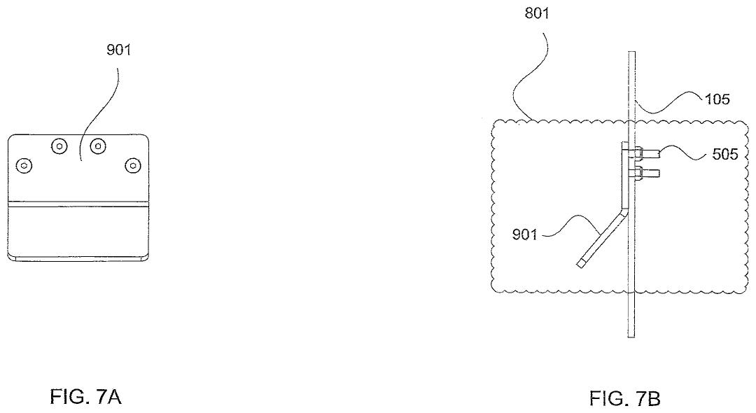

Referring now also to FIGS. 6, 7A, and 7B in the drawings, an alternative embodiment of unloader 101 is shown. In this embodiment, instead of having front pallet catch 401 that uses a spring hinge 501, this embodiment uses a static front pallet catch 801. Front pallet catch 801 is depicted as comprising an angled metal catch 901 along with mounting hardware 505 to mount static front pallet catch 801 to the sidewall of the product receptacle 105. The static pallet catch is installed so that catch 801 protrudes out from the wall of the product receptacle 105. Since catch 801 is static, catch 801 will not be moved out of the way for non-pallet type containers.

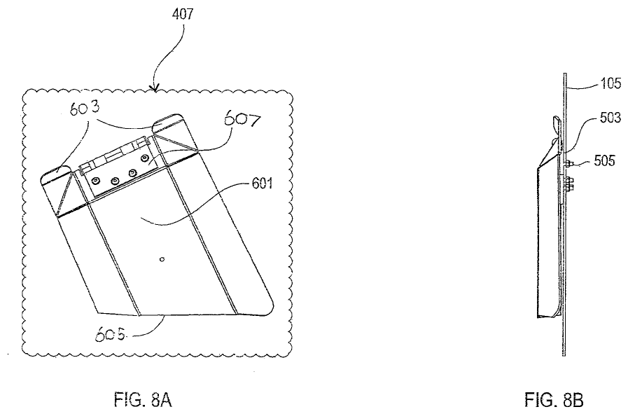

Referring now also to FIGS. 8A and 8B in the drawings, a self-retracting pallet catch 407 is depicted as comprising a pallet catch plate 601 with a stop surface 603; an edge surface 605; a hinge 607 that allows the pallet catch plate 601 to swing freely; a spacer plate 503; and mounting hardware 505 to mount the side self-retracting pallet holder 407 to the product receptacle 105. As the product receptacle is rotated, gravity allows the self-retracting pallet catch 407 to swing until the stop surface 603 pushes on product receptacle 105. Edge surface 605 of the pallet catch plate 601 is extended outward to catch the top of a pallet when hinge 607 is fully extended out. Several alternative embodiments are foreseen. It is understood that alternative embodiments of the self-retracting pallet catch may also be assisted by using a spring; powering self-retracting pallet catch 407 to move when turned on; and/or using sensors where self-retracting pallet catch 407 may move into place when containers placed in receptacle 105 are detected by a sensor.

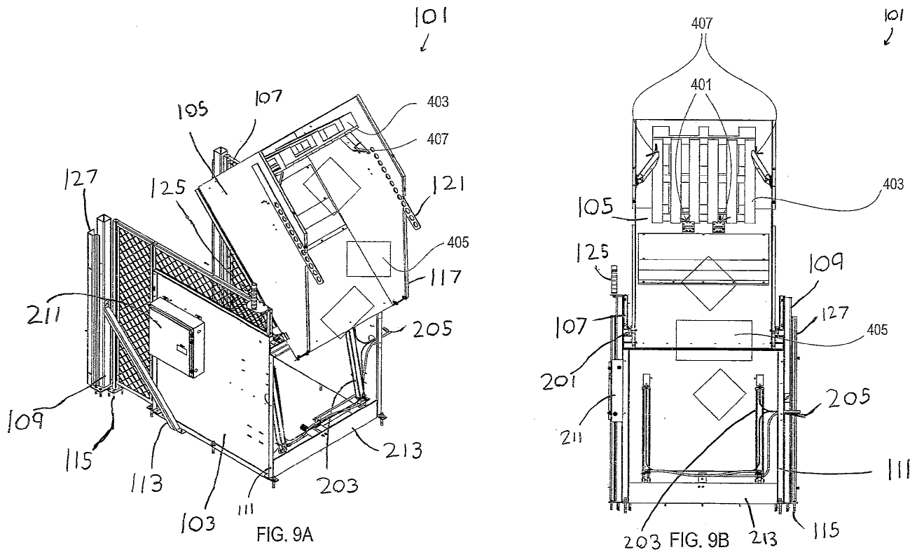

Referring now also to FIGS. 9A and 9B in the drawings, an unloader system 101 is depicted unloading a pallet 403 with product 405 falling out of the product receptacle 105. Front pallet catch 401 and self-retracting pallet catch 407 are in the out position. The pallet 403 is captured on two or more sides preventing pallet 403 from falling into the unloading area. Self-retracting pallet catch 407 is mounted at an angle such that hinge 607 will swing out due to gravity before pallet 403 begins to fall. With self-retracting pallet catch 407 swung out the opening is too small for pallet 403 to fall in. Unloader system 101 will rotate product receptacle 105 back to the rest position (FIG. 1). Hinges 607 allow self-retracting pallet catch 407 to swing out until stop surface 603 is flush with the side walls of product receptacle 105 retaining the pallet in product receptacle 105. As product receptacle 105 is rotated into the rest position, self-retracting pallet catch 407 swings flush with the sides of pallet receptacle 105 allowing pallet 405 to be removed without constraint.

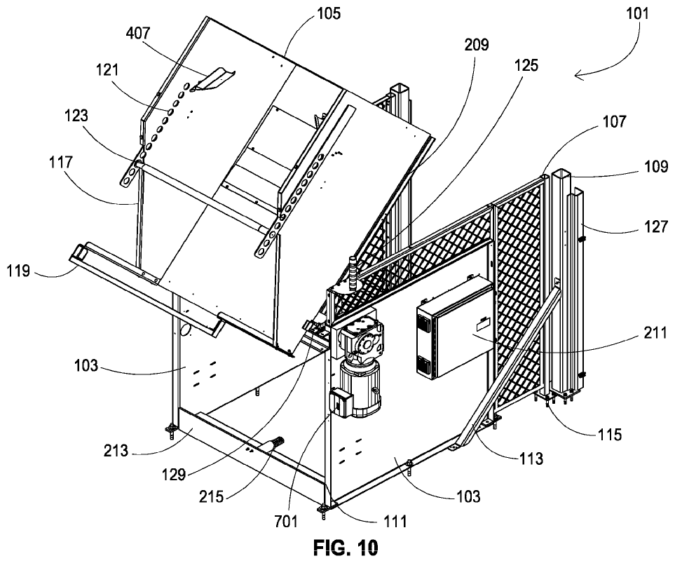

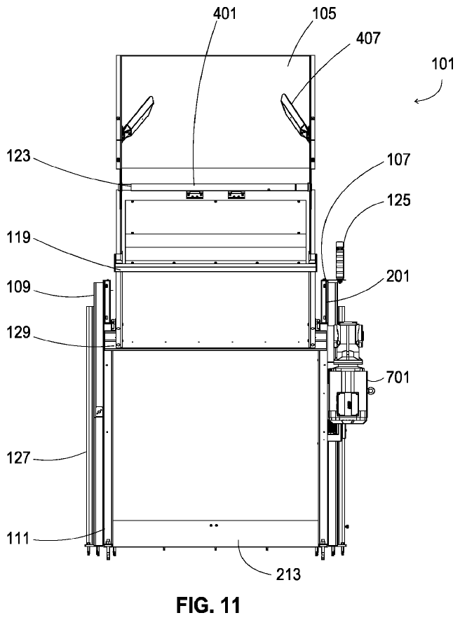

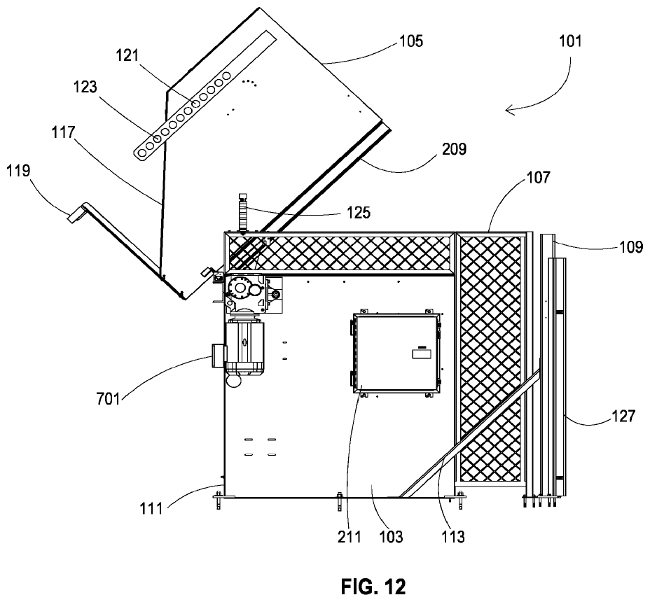

Referring now also to FIGS. 10-12 in the drawings, an alternative embodiment of unloader 101 is shown. In this embodiment, instead of having linear actuators 203 to lift receptacle 105, this embodiment uses rotary motor 701. Rotary motor 701 is located on the outer side of unloader frame side walls 103 towards the back of unloader 101 where rotational joint 201 and receptacle attachment bar 207 are located. Rotary motor 701 works by rotating rotational joint 201 which in turn rotates attachment bar 207 attached to the top of receptacle 105. Attachment bar 207 will then rotate receptacle 105 from the rest position to the active position seen in these figures. Back limit bar 129 will prevent rotary motor 701 from rotating receptacle 105 to the point where contents will exit receptacle 105 at a speed where the contents will break when landing in the loading area. While the present application depicts rotary motor 701 rotating receptacle 105 from the top of receptacle 105, it is appreciated that an alternative embodiment may exist where attachment bar 207 may be located at any vertical position on receptacle 105 for rotation by rotary motor 701. It is also appreciated that an alternative embodiment may exist where more than one rotary motor 701 is used in unloader 101. It is apparent that a system with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A product unloader for a product sortation system, comprising:
a main loader area defined by a pair of unloader frame side walls;
a moveable product receptacle disposed at least partially within the main loader area;
at least one front pallet catcher mounted within the product receptacle; and
at least one self-retracting pallet catcher mounted within the product receptacle.

2. The product unloader of claim 1, wherein the self-retracting pallet catcher further comprises:
a hinge mounted to the product receptacle; and
a pallet catch plate connected to the hinge;
wherein the pallet catch plate rotates has stop surface and an edge surface.

3. The product unloader of claim 1, wherein the front pallet catcher comprises:
a spacer plate mounted to the product receptacle;
a springe hinge mounted to the spacer plate; and
a hinge stop mounted to the spring hinge.

4. The product unloader of claim 1, wherein the front pallet catcher comprises:
a spacer place mounted to the product receptacle; and
a angled static metal catch mounted to the spacer plate.

5. The product unloader of claim 1, wherein the self-retracting pallet catcher further comprises:
a hinge mounted to the product receptacle; and
a pallet catch plate connected to the hinge;
wherein the pallet catch plate rotates has stop surface and an edge surface.

6. The product unloader of claim 1, wherein the unloader frame side walls are statically mounted to the ground.

7. The product unloader of claim 1, wherein the unloader frame side walls comprise:
a back limit bar connecting the top of the support frame side walls.

8. The product unloader of claim 1, wherein the unloader frame side walls comprise:
a support frame back base connecting the bottom of the support frame side walls; and
a support spring disposed within the support frame oriented towards the main loader area.

9. The product unloader of claim 1, wherein a pair of wire fence walls are connected to the front and top of the unloader frame side walls.

10. The product unloader of claim 9, wherein a lamp stack is attached at a top back portion of at least one of the wire fence walls.

11. The product unloader of claim 8, wherein a pair of safety curtain support bars are attached to a front portion of the wire fence walls.

12. The product unloader of claim 1, wherein the product receptacle comprises:
at least one container stop extending out over the product receptacle.

13. The product unloader of claim 1, wherein the product receptacle comprises:
one or more fastening holes in at least one of the sides of the product receptacle; and
at least one adjustable container stop which can be moved relative to the one or more fastening holes.

14. The product unloader of claim 1, wherein the product receptacle is raised into the active position and lowered into the rest position using at least one linear actuator.

15. The product unloader of claim 1, wherein the product receptacle is raised into the active position and lowered into the rest position using at least one rotary motor.

16. The product unloader of claim 1, further comprising:
at least one rotational joint on the inner sides of the unloader frame side walls; and
a receptacle attachment bar connecting the product receptacle to the rotational joints.
